(19) United States
(12) Patent Application Publication
(10) Pub. No.: US 2006/0074738 A1
(43) Pub. Date: Apr. 6, 2006

(54) Computer-implemented system and method for generating construction specifications

(75) Inventors: Bill Russell Vanhoose, Findlay, OH (US); Carl Raymond Douglass III, Findlay, OH (US); William E. Altermatt, Findlay, OH (US)

Correspondence Address: STEPHEN D. SCANLON, JONES DAY, 901 LAKESIDE AVENUE, CLEVELAND, OH, 44114, US

(73) Assignee: Media Plus, Inc.

(21) Appl. No.: 11/224,420

(22) Filed: Sep. 12, 2005

Related U.S. Application Data
(60) Provisional application No. 60/609,690, filed on Sep. 14, 2004.

(51) Int. Cl. G06F 9/46

(52) U.S. Cl. 705/8

(57) ABSTRACT

Computer-implemented systems and methods for generating specifications for construction projects. A method can be configured to generate user interfaces in order to obtain construction project details from a user. The construction project details can include what types and conditions are related to the construction project. Textual specification data is retrieved from a data store based at least in part upon the construction project details. A specification is generated based upon the retrieved textual specification data for use within a construction project.

### CROSS-REFERENCE TO RELATED APPLICATION

This application claims priority to and the benefit of U.S. Provisional Application Ser. No. 60/609,690, filed on Sep. 14, 2004, of which the entire disclosure (including any and all figures) is incorporated herein by reference.

### TECHNICAL FIELD

This document relates generally to generating specifications, detail drawings, and/or construction notes for construction projects and more particularly to computer-implemented construction specification generation.

### BACKGROUND

Currently, engineers, architects, and designers typically create their own site and infrastructure, facility construction, facility services, process equipment, and/or general requirement portions of construction project specifications by manually performing research and compiling information to draft a construction project specification. Materials used to create the specification change rapidly thereby requiring considerable time and resources for the specifiers to update and maintain a quality construction project specification. Additionally, specification language for materials (e.g., materials, handling, and installation guidelines) from product to product is often inconsistent in format and/or content and is not readily comparable for similar project conditions. Moreover, construction specifications are not typically based on project specific conditions.

### SUMMARY

In accordance with the teachings provided herein, systems and methods for operation upon computing devices are provided in order to overcome one or more of the aforementioned disadvantages or other disadvantages concerning the generation of construction project specifications. For example, a computer-implemented system and method can be configured to generate user interfaces in order to obtain construction project details from a user. The construction project details can include what types and conditions are related to the construction project. Textual specification data is retrieved from a data store based at least in part upon the construction project details. A specification is generated based upon the retrieved textual specification data for use within a construction project.

As another example of a system and method, a user can specify information to a construction project generator software module that indicates what construction product types, criteria and conditions the user needs in order to generate a specification document for a construction project. A user can select different types of products as well as select different project conditions.

As another example, a system and method can include best practices based upon industry practices or other Federal (e.g., EPA), State, Municipal, or regional standards. Still further, a system and method can be configured to maintain consistency in specification requirements in that if one product requires a particular performance or quality level, then other products specified will have that requirement imposed upon them as well (e.g., if a user has specified that recycled materials be used, other products will be made to conform to the recycled materials requirement). A system and method can also address project construction cradle-to-grave type issues (e.g., product type handling, submittal, installation, testing and maintenance issues). Furthermore, different product types can be compared, and the comparison analysis can be provided to the user. As an illustration, based upon the user input, it may be determined that a different product type might work better based upon the conditions specified by the user.

### BRIEF DESCRIPTION OF THE DRAWINGS

FIG. 1 is a block diagram depicting a computer-implemented system that creates site and infrastructure, facility construction, facility services, process equipment, and/or general requirement portions of a construction project specification.

FIGS. 2A and 2B are flowcharts depicting an example operational scenario for generating construction project specifications based upon user input.

FIGS. 3-16 are user interface screens wherein a step-by-step process is used to step a user through a construction specification generation decision process.

FIGS. 18-20 are displays depicting portions of an example textual specification truth table.

FIGS. 21-22 depict an alert table containing conditions which, if satisfied, will result in alert text being sent to the user.

FIG. 23 is a block diagram depicting a single general purpose computer or workstation implementation.

### DETAILED DESCRIPTION

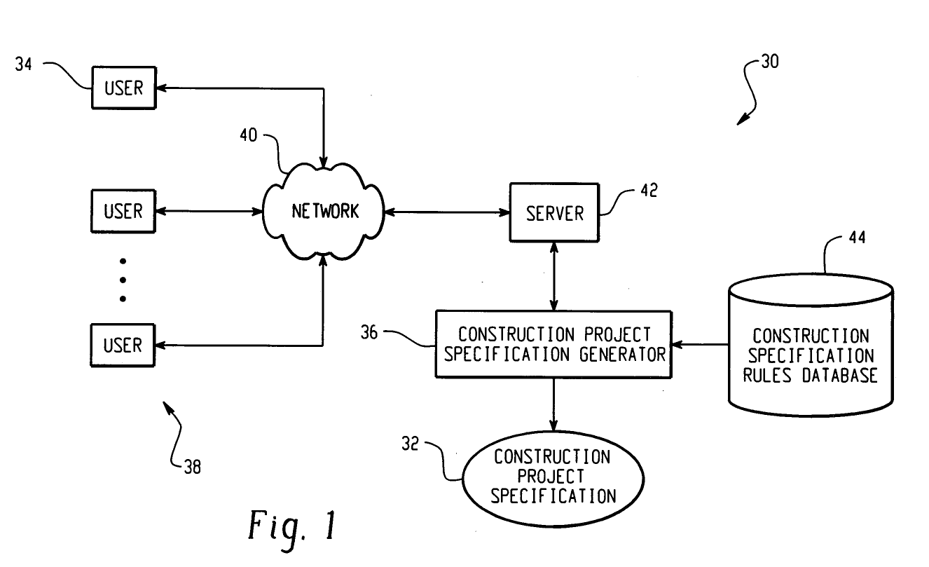

FIG. 1 depicts at 30 an example of the computer-implemented system that creates a construction project specification 32 for users. A user 34 specifies piping-related information to a construction project specification generator software module 36 that indicates what construction materials, criteria and conditions the user 34 needs to address in order to generate a specifications document 32 for the construction project. For example, the user 34 can select different types of construction materials as well as select site specific project conditions which may include, and without limitation to, burial depth, effluent conditions, soil conditions, sewer pipe joint requirements, etc.

Users 38 can provide data and otherwise interact with the construction project generator software module 36 over a network 40. The users can be from many different professions that need to generate specifications, such as architects, engineers, and design build firms.

The network 40 can include a local area network (LAN), intranet network, wide area network (WAN), and/or Internet network. A server 42 can contain the construction project generator 36 which can be made accessible to the users 38 via the network 40.

The construction project generator software module 36 receives the user-specified construction information which is processed to generate a site and infrastructure, facility construction, facility services, process equipment, and/or general requirement portions of a construction project specification 32 to help ensure that the products are correctly specified in the generated specification 32 for the user's application. To construct the construction project specification 32, the module 36 retrieves data from a construction specification rules database 44. The database 44 provides the rules that determine what textual specification portions should be used by the module 36 based upon the user-specified input.

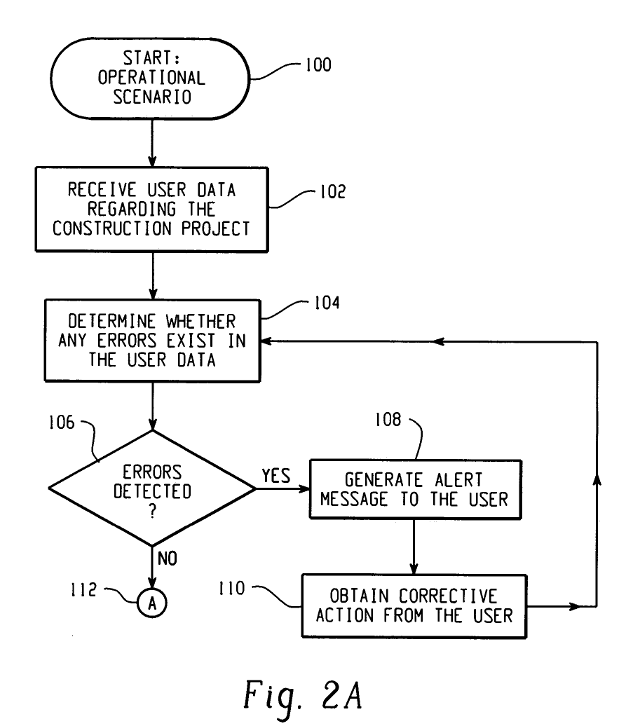

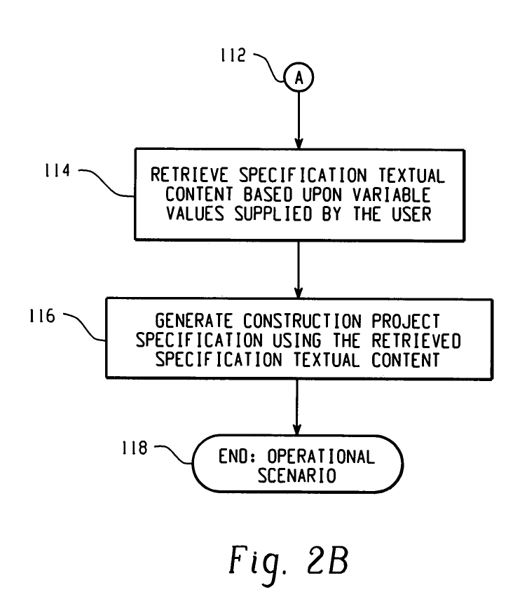

FIGS. 2A and 2B depict an example operational scenario for generating construction specifications based upon user input. With reference to FIG. 2A, the start indication block 100 indicates that processing for this operational scenario begins by interacting with a user in order to receive user data at step 102 for a construction project. After user data is received, there is a determination at step 104 as to whether any errors or possible anomalous situations may exist with respect to the user-specified data. If errors or possible anomalies are detected at decision step 106, then an alert is generated at step 108 to the user advising the user of a potential problem, and the program obtains corrective action from the user at step 110.

However if there are no errors or anomalous situations, then processing continues at step 114 on FIG. 2B as indicated by continuation indicator 112. With reference to FIG. 2B, textual specification content is retrieved at step 114 from a data store based upon the site specific project data supplied by the user. The construction project specification is then generated at step 116 using the retrieved textual specification content. The program may format the specification output in many different ways, such as specifying construction materials, installation, and general requirements in a standardized format which can include Construction Specifications Institute (CSI) format. Processing for this operational scenario ends as indicated by block 118.

It should be understood that similar to the other processing flows described herein, the steps and the order of the steps in the flowchart described herein may be altered, modified, deleted, and/or augmented and still achieve the desired outcome. For example, the program can use up-to-date information for the stored textual specification that is based on manufacturers' recommendations, trade association recommendations, and industry standards, thereby providing the best solution for the application. A generated construction project specification can be used on both private and public construction projects and can be used for many different products, such as catch basins and any other sub-surface or above ground construction products, such as geotextile products (e.g., Silt Fence), architectural elements, structural elements, paving construction, landscape elements, best management practices (BMPs), decorative or aesthetic flags, etc.

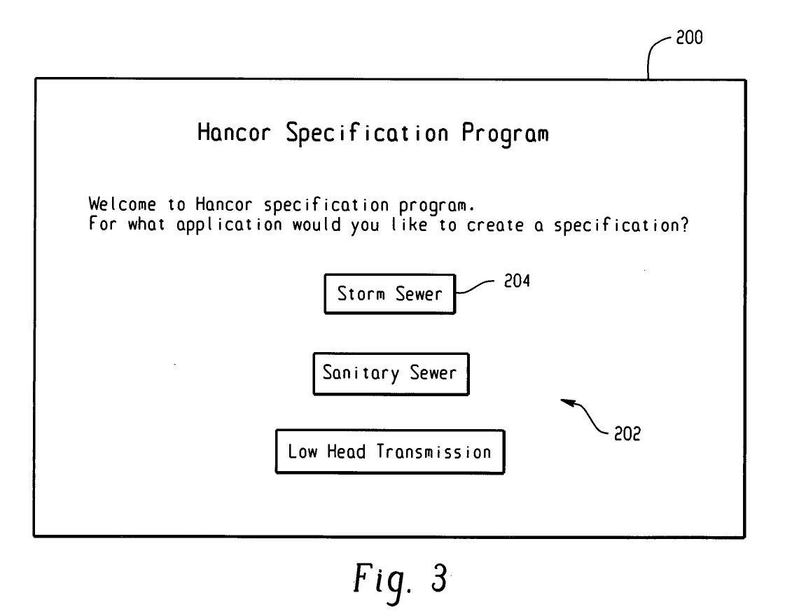

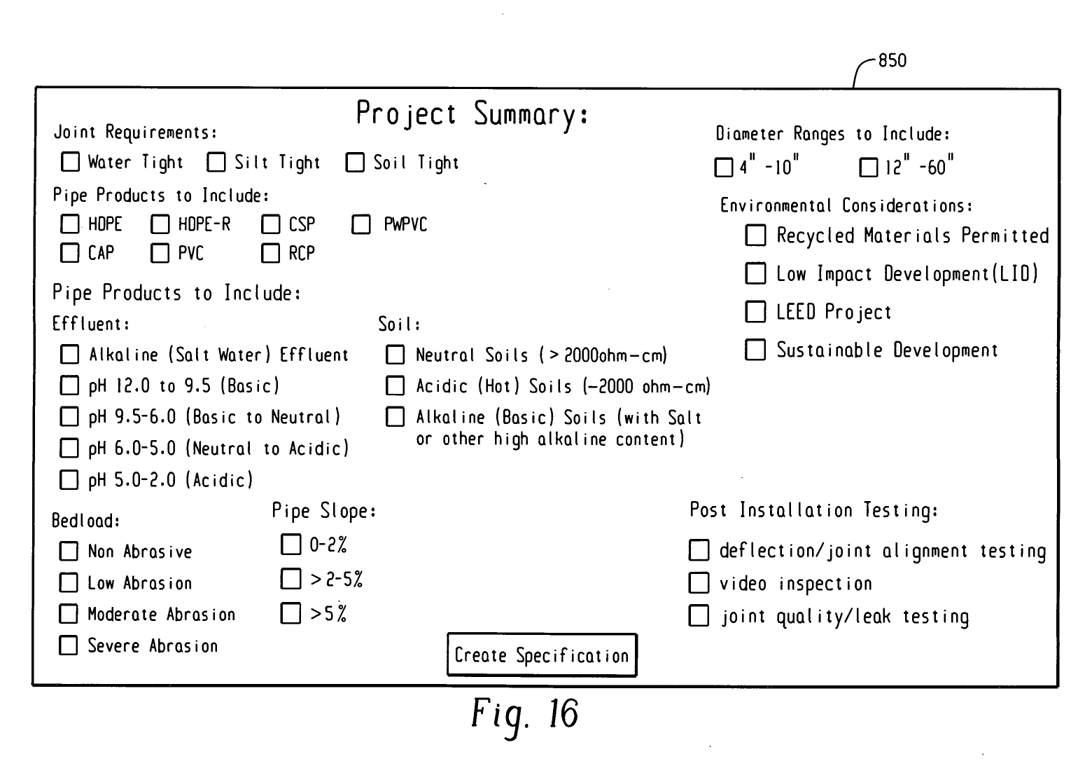

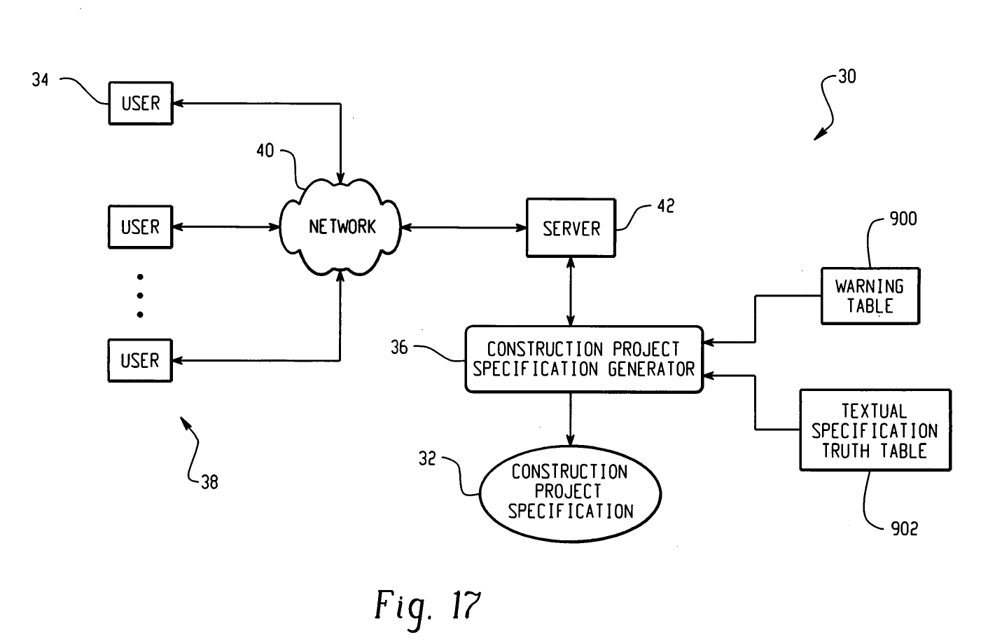

FIGS. 3-16 show user interface screens wherein a step-by-step help option is used to step a user through a construction specification generation decision process. Although the user may use the step-by-step option, the user also has the capability to go directly to a project summary screen, such as the screen 850 shown on FIG. 16 and specify the user input on the interface 850 of FIG. 16.

If a user does use the step-by-step help option, then the project summary interface 850 shown in FIG. 16 will be populated with the user's selections and the user can have the option of changing one or more selections. If a user does change one or more selections in the project summary, then the information from the rules database is applied to the changes to ensure that the selection modifications are being made properly. After the user has provided the selections, then the construction textual specification is automatically generated based upon accessing the rules database that determines what textual portions are to be used based upon the user selections. The generated specification can be in a text format so that any word processing program can access it and the user can make changes to the document if they so wish.

The step-by-step option allows the user to step backwards and forwards through the different input screens, thereby allowing a user to more easily change options selected in previous steps. The screens can be web pages accessible over a network such as over the world-wide web (web). The web is a method of accessing information on the Internet which allows a user to navigate the Internet resources intuitively, without IP addresses or other technical knowledge. A user's computer can contain client software, known as a web “browser,” which is used to display web pages as well as traditional non-web files on the client system.

FIG. 3 shows an example of a first step in the construction project specification creation program. In FIG. 3, an interface 200 is provided wherein a user can select from multiple application options 202. The user selects an option for which the specification is to be generated. In this operational scenario, the first option “Storm Sewer” 204 is selected.

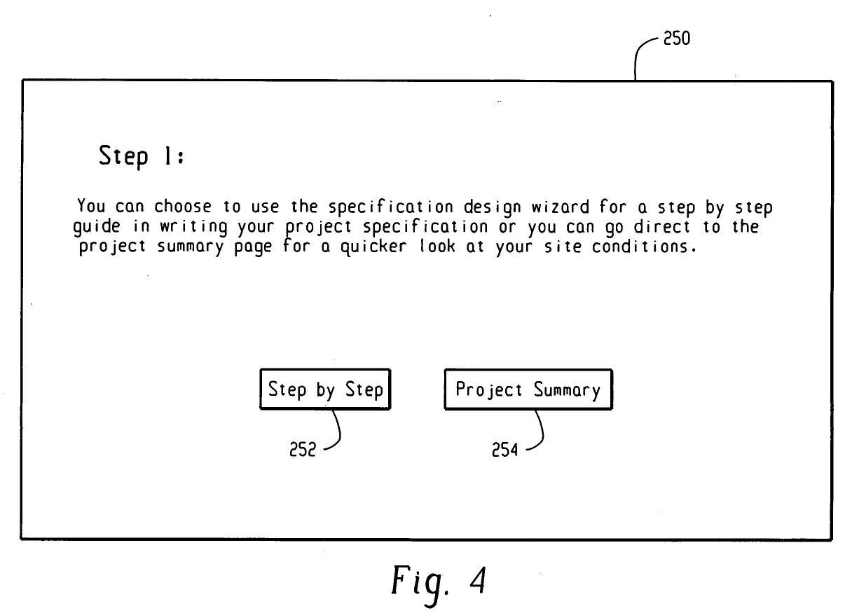

In the next step of the construction project specification creation program, FIG. 4 provides an interface 250 wherein a user can choose either to use the step-by-step wizard via option 252 or can directly proceed to the project summary interface of FIG. 16 via option 254. In this operational scenario, the user selects the step-by-step option 252.

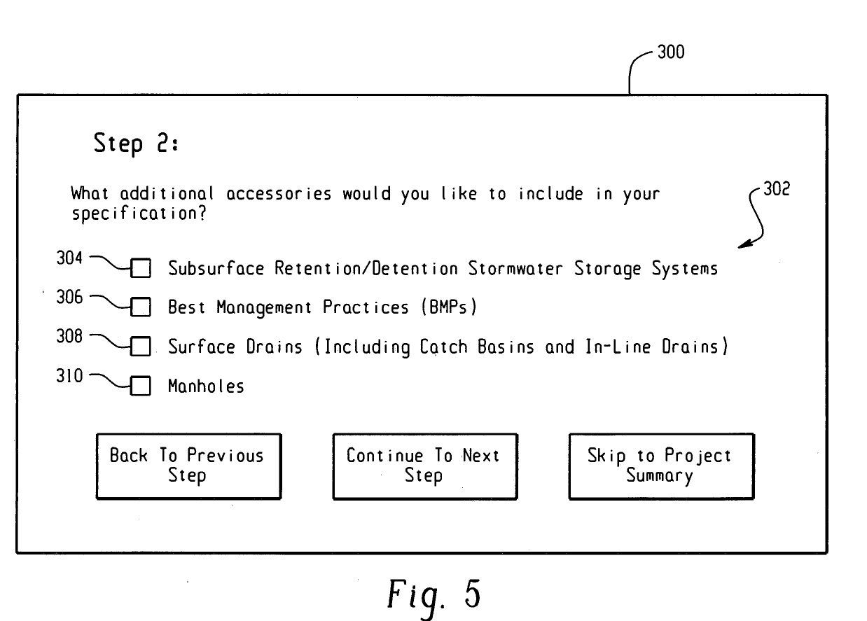

FIG. 5 provides an interface 300 wherein a user is asked about what additional accessories 302 the user would like to include in the specification. As an illustration, the user can include such additional accessories 302 as specifying subsurface retention/detention stormwater water storage systems at 304, best management practices (BMPs) at 306, surface drains (e.g., catch basins and in-line drains) at 308, or manholes at 310.

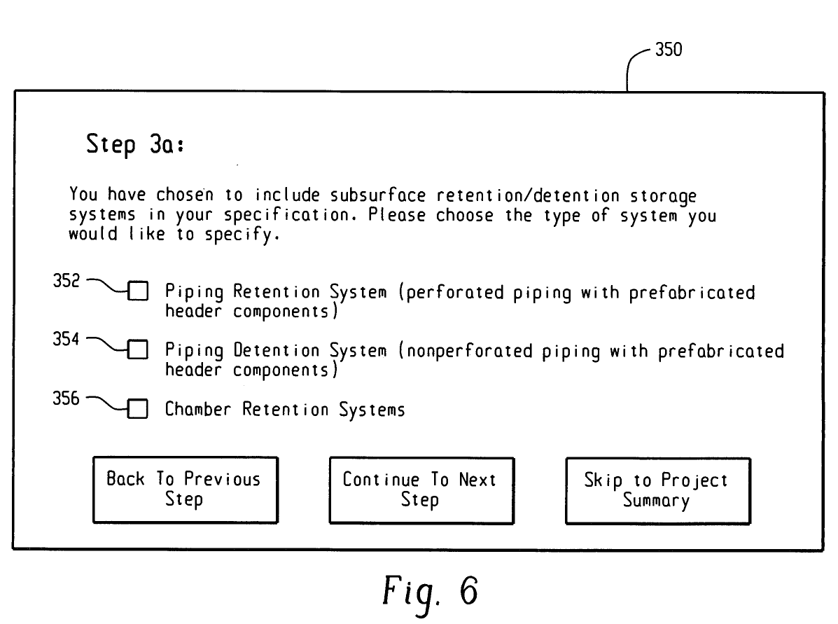

If the user had chosen in FIG. 5 to include subsurface retention/detention storm systems at 304 in the specification, then the interface 350 of FIG. 6 is presented to the user. The interface of FIG. 6 allows the user to choose the type of system they would like to specify. The user can specify a piping retention system at 352, a piping detention system at 354, or chamber retention systems at 356.

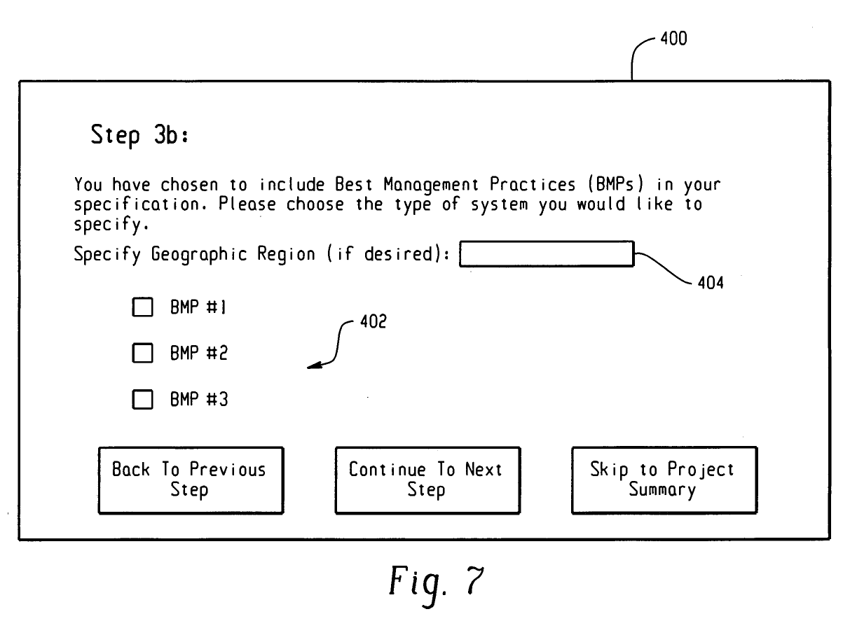

Additionally, if the user had chosen at 306 in FIG. 5 to include the best management practices in the specification, then the interface 400 of FIG. 7 is provided to the user. The interface 400 of FIG. 7 allows the user to select one or more best management practices 402. Such practices may be based upon which geographical region the construction is to take place. As an illustration, a best management practice may include indicating to a user that for the geographical region where the project is to occur, silt prevention products should be used on the entire construction project in order to prevent debris runoff. A user can specify a geographical region at 404.

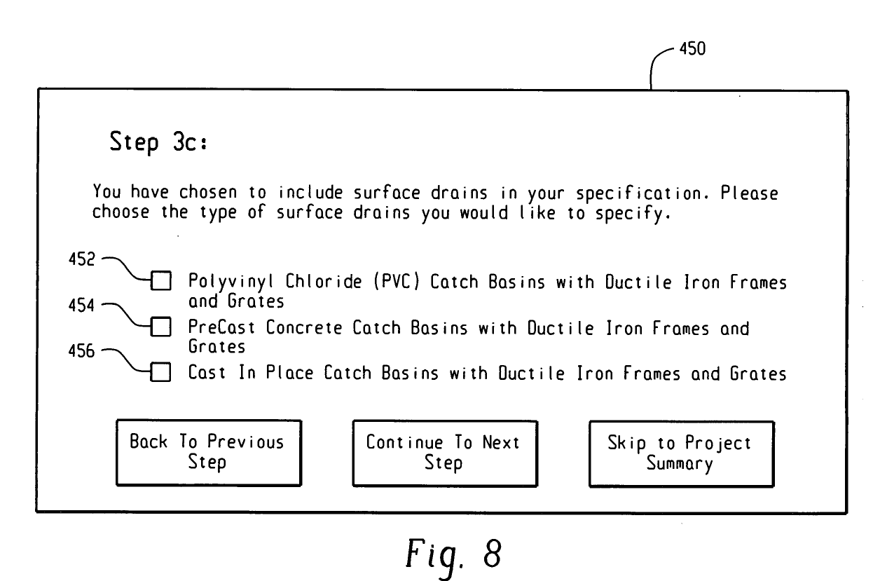

If the user had chosen at 308 in FIG. 5 to include surface drains in the specification, then the interface 450 of FIG. 8 is presented to the user. The interface 450 of FIG. 8 allows the user to choose the type of surface drains the user would like to specify. For example, the user can specify at 452 polyvinyl chloride (PVC) catch basins with ductile iron frames and grates. Other options may include pre-cast concrete catch basins with ductile iron frames grates at 454 or cast in-place catch basins with ductile iron frames and grates at 456.

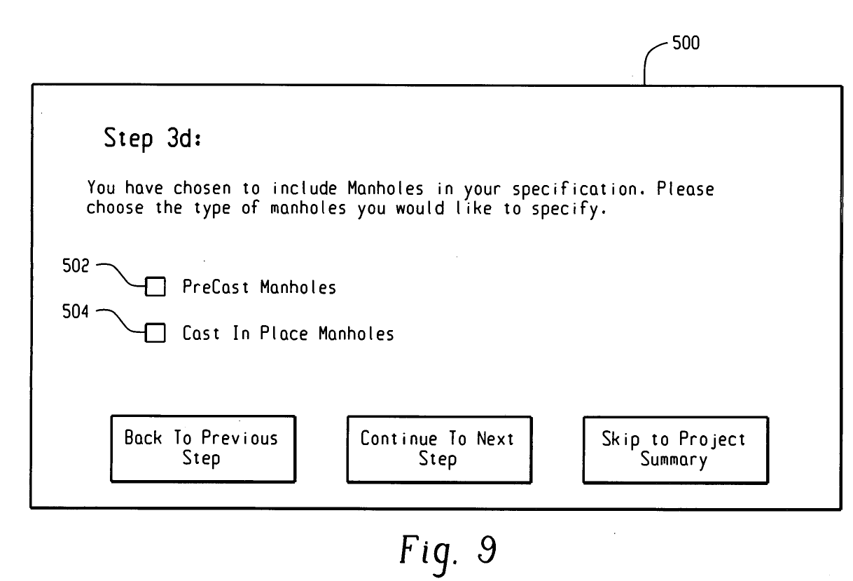

If the user had chosen at 310 in FIG. 5 to include manholes in the specification, then the interface 500 of FIG. 9 is presented to the user wherein the user can choose the type of manholes the user would like to specify. As an illustration, the user can select pre-cast manholes at 502 or cast in-place manholes at 504.

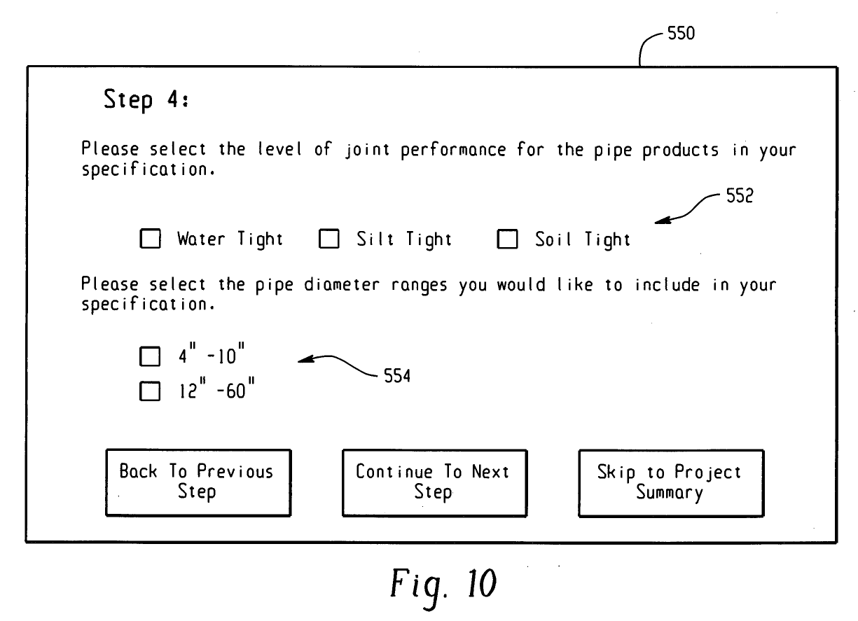

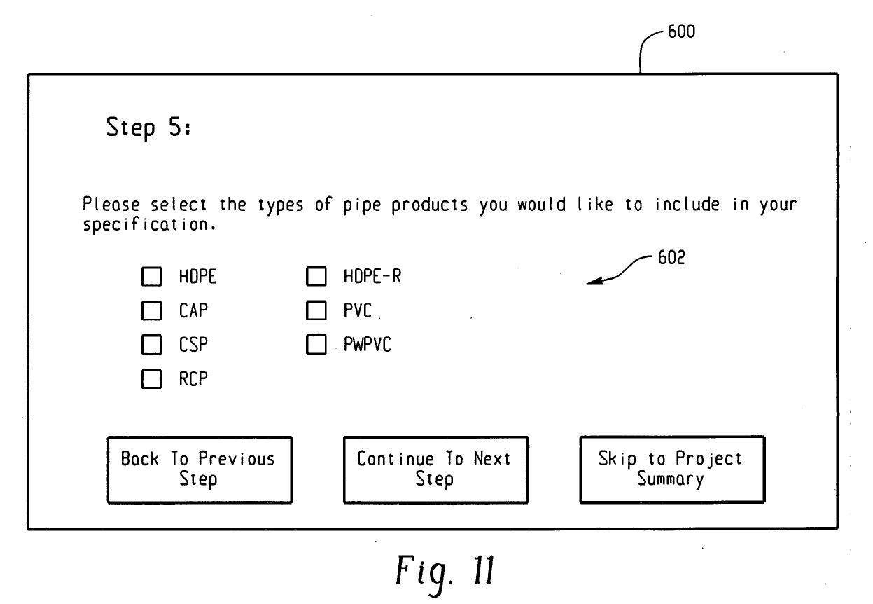

FIG. 10 provides an interface 550 wherein a user can select at 552 the level of joint performance for the pipe products in the specification (e.g., watertight, silt tight, or soil tight). The user can also select at 554 diameter ranges that the user would like to include in the specification. Different pipe diameter ranges can be used, such as the ones shown in this example operational scenario which include the diameter ranges of 4 inches to 10 inches and 12 inches to 60 inches.

FIG. 11 provides an interface 600 wherein a user can select at 602 types of pipe products that the user would like to include in the specification (e.g., Corrugated HDPE Pipe, Corrugated Aluminum Pipe (CAP), Corrugated Steel Pipe (CSP), Reinforced Concrete Pipe (RCP), Recycled Corrugated HDPE Pipe (HDPE-R), Polyvinyl Chloride Pipe (PVC), Profile-Wall Polyvinyl Chloride Pipe (PWPVC), etc.).

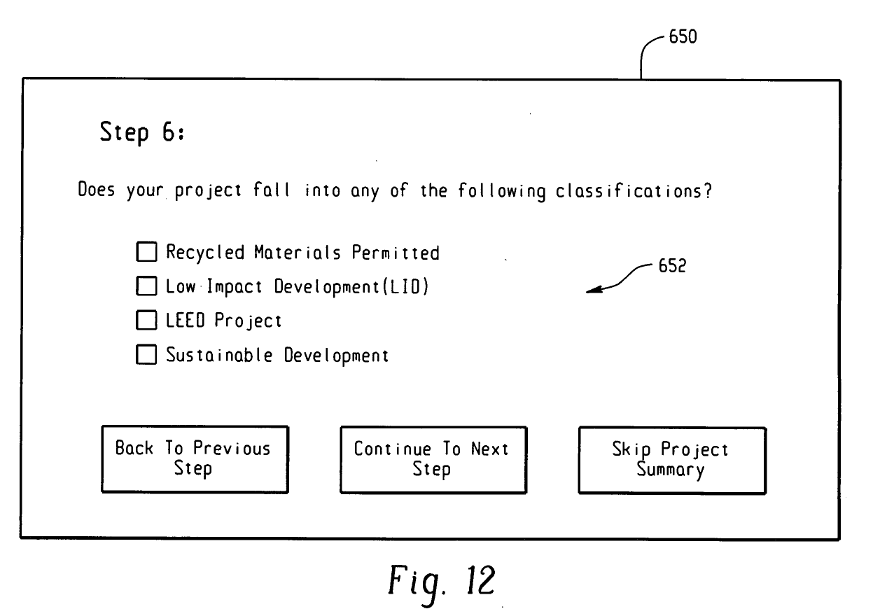

FIG. 12 provides an interface 650 wherein a user can specify at 652 whether the user's project falls within a certain type of project (e.g., whether the project might be environmentally sensitive). As an illustration, a project may involve whether recycled materials are permitted, whether a low impact development is involved, whether the project is a LEED type project (wherein LEED stands for Leadership in Energy and Environmental Design), or whether the project is a sustainable development type of project. It is noted that these types of questions presented to a user may typically not be considered by a user. Therefore, stepping the user through the step-by-step process allows the user to consider questions that she may not have previously considered.

If a user indicates that a particular environmentally-related material is to be used (e.g., recycled materials), then this selection can be used to influence choices made earlier or to be made later by the user, such as to restrict what product types the user can indicate for the project. For example, the user may be asked whether the user would like to reconsider their selection in step 5 if the user had selected a non-environmentally-sensitive material in step 5, but had indicated in step 6 that recycled materials should be used for the project.

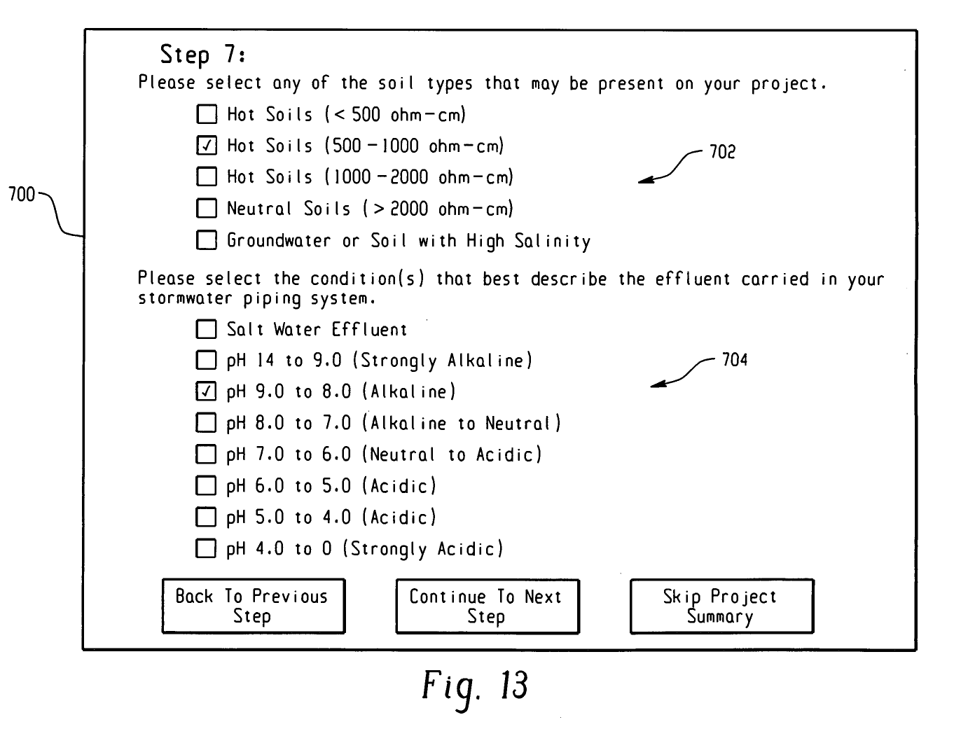

FIG. 13 provides an interface 700 wherein a user can select at 702 a soil type that may be present on the project. A soil type may include neutral soils (e.g., soils that have greater than 2000 ohm-cm), hot soils (e.g., less than 2000 ohm-cm), or soils or groundwater with high salinity or salt content. The user can also select at 704 the conditions that best describe the effluent carried into storm water piping systems. Options may include, Salt Water Effluent, pH 14.0 to 9.0 (Strongly Alkaline), pH 9.0 to 8.0 (Alkaline), pH 8.0 to 7.0 (Alkaline to Neutral), pH 7.0 to 6.0 (Neutral to Acidic), pH 6.0 to 5.0 (Acidic), pH 5.0 to 4.0 (Acidic), pH 4.0 to 0 (Strongly Acidic).

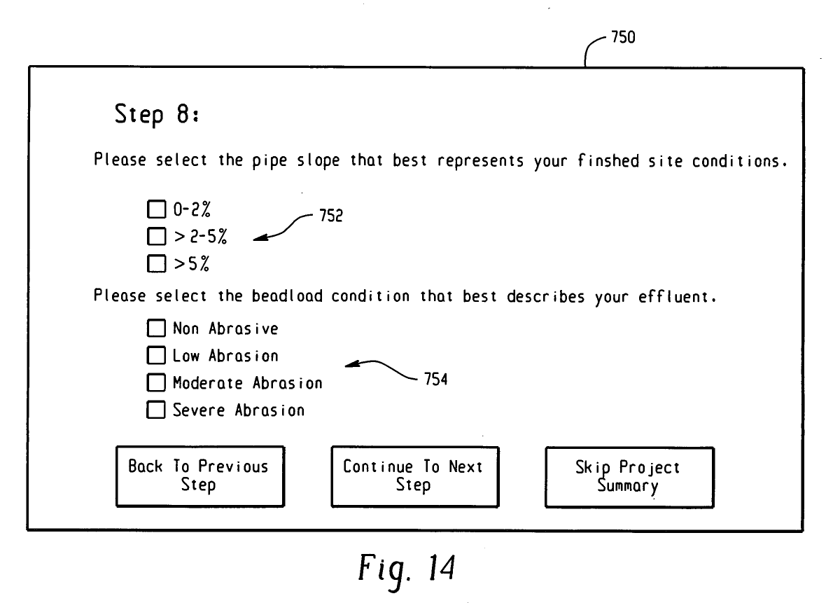

FIG. 14 provides an interface 750 wherein a user can specify at 752 a pipe slope that best represents the finished site conditions. A pipe slope may include such pipe slope values as 0 to 2%, greater than 2 to 5%, or greater than 5%. The user may also select at 754 the bedload conditions that best describes the effluent condition. A bedload condition may include such values as non-abrasive, low abrasion, moderate abrasion, or severe abrasion.

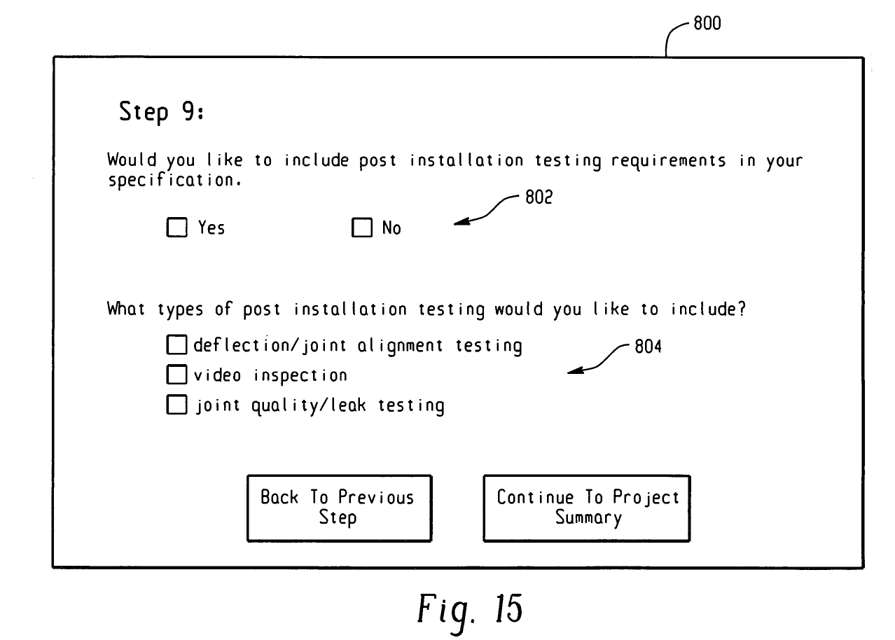

FIG. 15 provides an interface 800 wherein the user can specify at 802 whether the user would like to include post installation testing requirements in the specification as well as what type of post installation testing the user would like to include. A post installation testing type may include deflection or joint alignment testing, video inspection, or joint quality and leak detection testing. Different types of post installation testing can be selected by the user at 804. The interface can also specify what testing is typically required for a geographical region.

FIG. 16 summarizes via interface 850 the values provided by the user in the previous steps and allows the user to change one or more values if the user so wishes. Moreover as shown on the screens in the previous steps, the user can choose to jump to the project summary screen 850 of FIG. 16 at anytime during the process.

Selection of certain product types and/or conditions could trigger alert messages that are provided to the user. As an illustration, an alert message can be generated if the user has selected to include a particular type of pipe that is not recommended to be used with effluents having a particular pH value. The alert could also recommend what product types work better in such conditions. An alert message can include a reference to the source material or a hyperlink to a web page that provides additional technical or regulatory information that is the underlying basis for the alert message.

FIG. 17 depicts a program 36 that assists users 38 in creating quality, comprehensive, and up-to-date specifications 32 for the construction materials, installation, and general requirements portions of a construction project specification. The program 36 allows a user 34 to select many types of the most commonly used product types and then helps to ensure the products are correctly specified for the application. The program 36 may prompt the user 34 to select common project conditions which may include, and without limitation to, burial depth, effluent conditions, soil conditions, joint requirements, etc. Once the user 34 selects the options specific to their project (or while the user 34 is selecting the option), the program 36 accesses information stored in an alert table 900 and a textual specification truth table 902.

The alert table 900 contains information for use by the program 36 to notify the user 34 if one or more conditions or products specified by the user 34 are inconsistent with respect to a technical or legal requirement, standard, or general good practice. The textual specification truth table 902 contains conditions which, if satisfied based upon user input, allow the program 36 to select the correct specification text for inclusion into the generated specification 32. An operator can update the alert table 900 and the truth table 902 as new information becomes available, such as if better practices are developed with respect to which materials are better suited for a particular situation, or new legal requirements arise in the industry, etc.

The program 36 can be extended to generate all or a portion of a project specification 32 in a standardized format (e.g., Construction Specifications Institute (CSI) format) and then allow the user 34 to further tailor the specification 32 to his or her project needs by editing and pasting into their master project specifications. The program 36 can be comprehensive and focus on project conditions and create a specification 32 based on those conditions. The program 36 can also focus on the installation of the included products. The program creates a specification 32 with multiple products that is tailored to the specific project conditions and has the capability of creating multiple sections of a project specification within the same program.

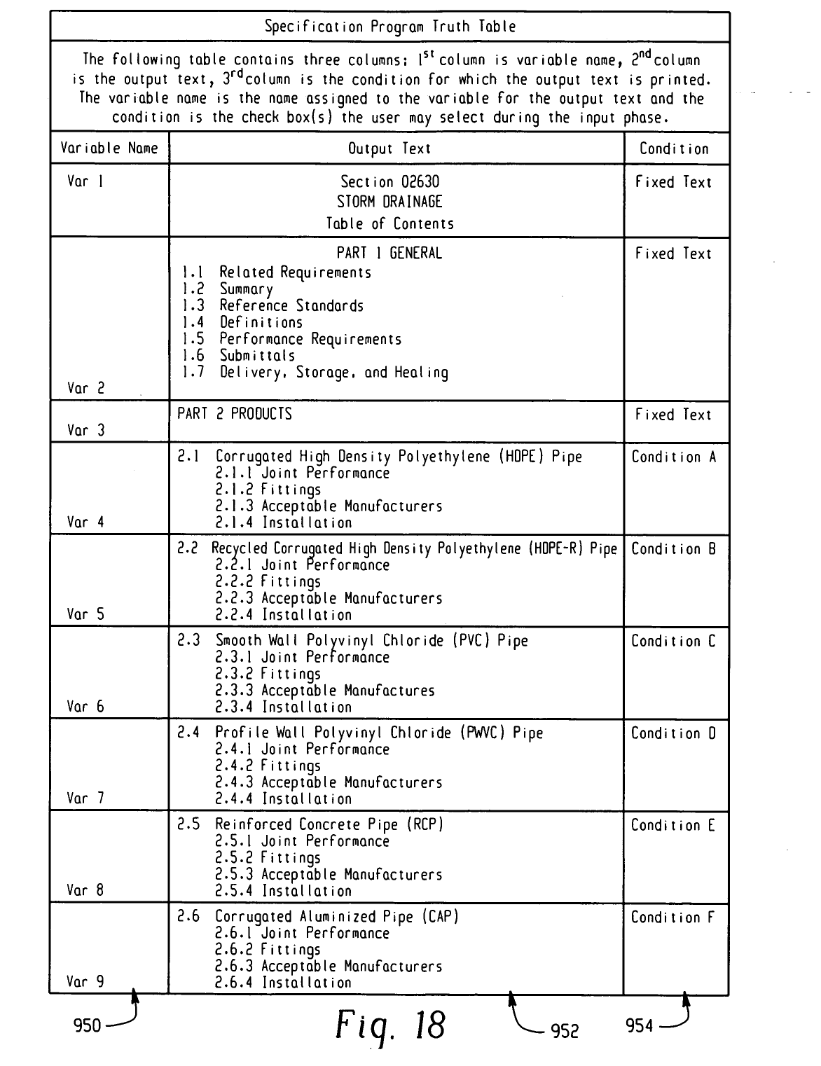

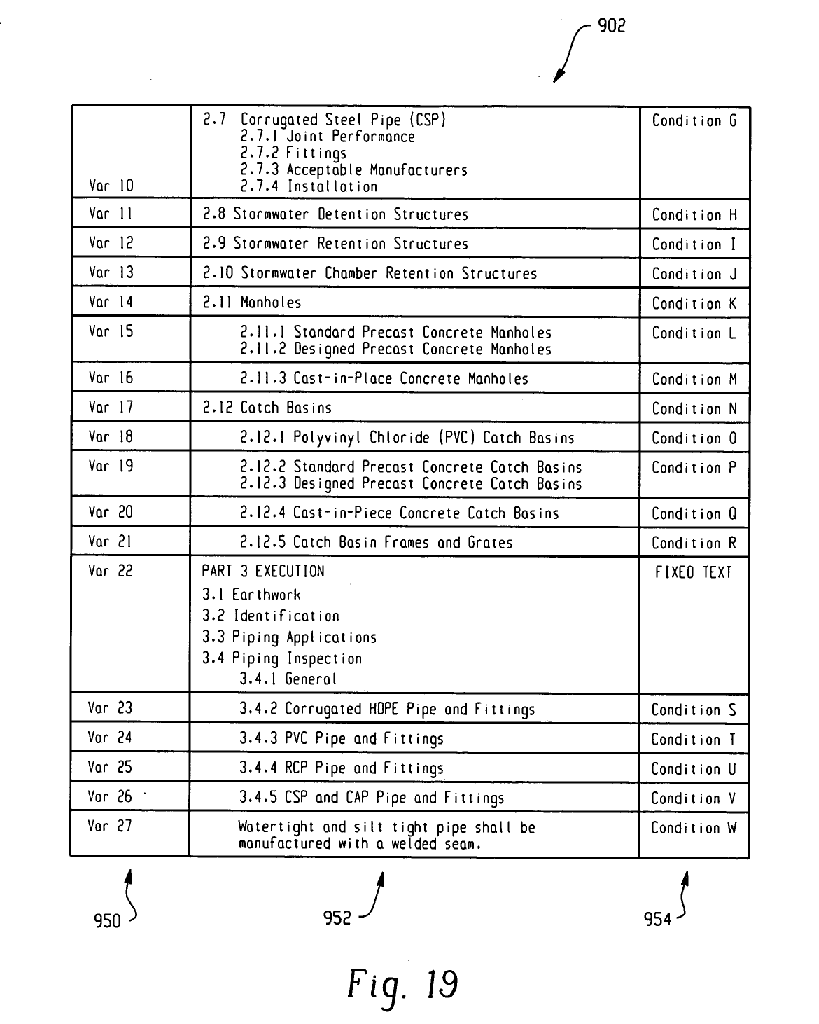

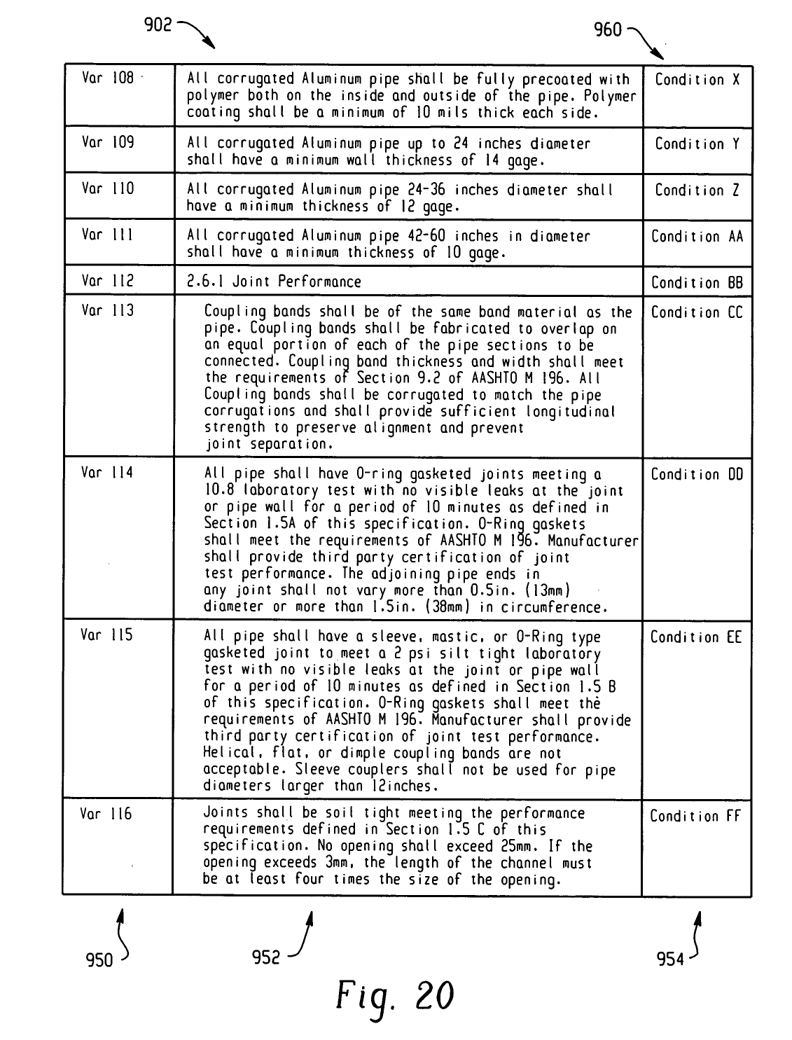

FIGS. 18-20 show a portion of an example textual specification truth table 902. The truth table 902 can be structured in many different ways. As illustrated in FIGS. 18-20, if the condition specified in the third column 954 is true, then the second column 952 of text is outputted to the specification. For example on FIG. 20, if the user specified corrugated aluminum pipe should be used and also specified condition A (which is a specific effluent condition, such as the water coursing through the pipe will have a pH of 12), then the condition specified in column three 954 of row 960 shown in FIG. 20 would be true. With the condition being true, then the row's corresponding text would be placed in the output specification. In this example, the corresponding text placed in the output specification is:
“All corrugated Aluminum pipe shall be fully precoated with polymer both on the inside and outside of the pipe. Polymer coating shall be a minimum of 10 mils thick each side.”

The variable name in column one 950 is the name assigned to the variable for the output text and the condition in column three 954 can correlate to the check box(es) the user may select during the user input phase.

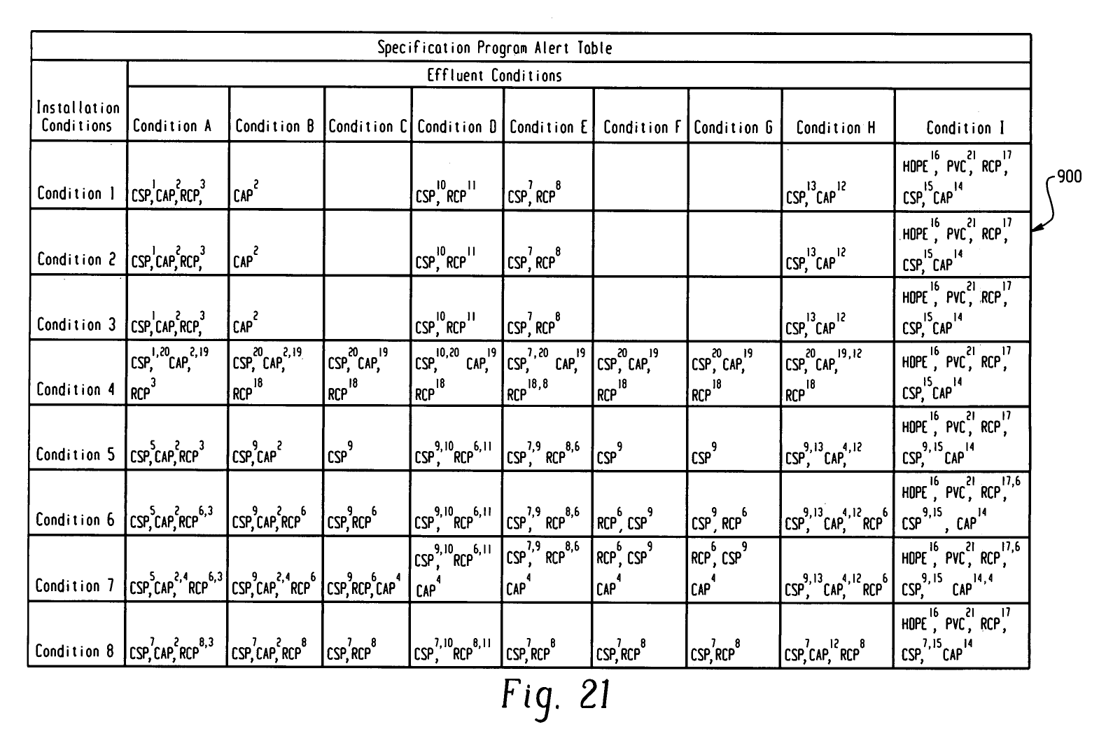

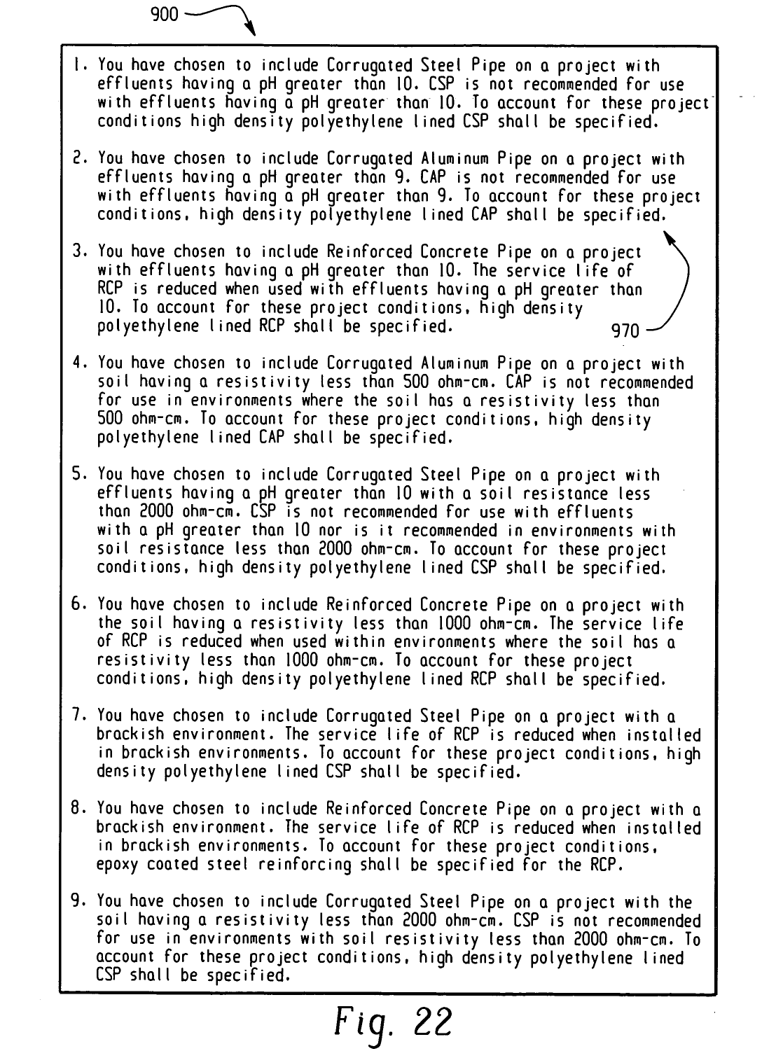

FIGS. 21-22 illustrate an alert table containing conditions which, if satisfied, will result in alert text being sent to the user. An installation condition might be the slope of the pipe or soil type. An effluent condition may include pH value of the water running through the pipe, or debris that might be running through the pipe. The alert may be provided to the user before the specification is generated.

The user can be offered options on how to handle the alert. Options may include an option to decline to address the alert (whereby the alert text may be included with the specification); an option to address the alert (whereby the user would be given an opportunity to correct the user input, such as to change the pH to be within an acceptable range). As an illustration if effluent condition A (e.g., the effluent has a pH greater than 9) and installation condition 1 (e.g., the soil type is acidic) are satisfied based upon the user input and corrugated aluminum pipe has been specified, then the second alert (i.e., alert 970) shown on FIG. 22 would be provided to the user before the specification is generated. Alert 970 reads as follows:
“Corrugated Aluminum Pipe is not recommended for use with effluents with a pH greater than 9. Would you like to modify your selections? If you choose not to modify your selections, non-metallic coated CAP shall be specified.”

The user would then have an opportunity to address the alert. The user could choose to handle it by selecting a pH value for that product type that would not generate the alert (e.g., a pH of 6).

While examples have been used to disclose the invention, including the best mode, and also to enable any person skilled in the art to make and use the invention, the patentable scope of the invention is defined by claims, and may include other examples that occur to those skilled in the art. For example, systems and methods disclosed herein may allow a user to access an interface which permits the user to dialog with a company representative via the computer. The user can then obtain help from a third party materials supplier company to chose the proper language to include the specification. Many different types of computer dialoguing mechanisms may be utilized, such as electronic mail, text messaging, or Internet videoconferencing (e.g., web casting).

As another example of the wide scope of the systems and methods described herein, the generated specifications may be formatted in many different ways, such as the following:

Section 02630

Storm Drainage

Table of Contents

Part 1—General

1.1 Related Requirements

1.2 Summary

1.3 Reference Standards

1.4 Definitions

1.5 Performance Requirements

1.6 Submittals

1.7 Delivery, Storage, and Handling

Part 2—Products

2.1 Corrugated High Density Polyethylene Pipe

2.1.1 Joint Performance

2.1.2 Fittings

2.1.3 Acceptable Manufacturers

2.1.4 Installation

2.2 Recycled Corrugated High Density Polyethylene (HDPE-R) Pipe

2.2.1 Joint Performance

2.2.2 Fittings

2.2.3 Acceptable Manufacturers

2.2.4 Installation

2.3 Smooth Wall Polyvinyl Chloride (PVC) Pipe

2.3.1 Joint Performance

2.3.2 Fittings

2.3.3 Acceptable Manufacturers

2.3.4 Installation

2.4 Profile Wall Polyvinyl Chloride (PVC) Pipe

2.4.1 Joint Performance

2.4.2 Fittings

2.4.3 Acceptable Manufacturers

2.4.4 Installation

2.5 Reinforced Concrete Pipe (RCP)

2.5.1 Joint Performance

2.5.2 Fittings

2.5.3 Acceptable Manufacturers

2.5.4 Installation

2.6 Corrugated Aluminum Pipe (CAP)

2.6.1 Joint Performance

2.6.2 Fittings

2.6.3 Acceptable Manufacturers

2.6.4 Installation

2.7 Corrugated Steel Pipe (CSP)

2.7.1 Joint Performance

2.7.2 Fittings

2.7.3 Acceptable Manufacturers

2.7.4 Installation

2.8 Stormwater Detention Structures

2.9 Stormwater Retention Structures

2.11 Manholes

2.11.1 Standard Precast Manholes

2.11.2 Designed Precast Manholes

2.11.3 Cast-in-Place Concrete Manholes

2.12 Catch Basins

2.12.1 Polyvinyl Chloride (PVC) Catch Basins

2.12.2 Standard Precast Concrete Catch Basins

2.12.3 Designed Precast Concrete Catch Basins

2.12.4 Cast-in-Place Concrete Catch Basins

2.12.5 Catch Basin Frame and Grates

Part 3—Execution

3.1 Earthwork

3.2 Identification

3.3 Piping Applications

3.4 Piping Inspection

3.4.1 General

3.4.2 Corrugated HDPE Pipe and Fittings

3.4.3 PVC Pipe and Fittings

3.4.4 RCP Pipe and Fittings

3.4.5 CSP and CAP Pipe and Fittings

3.5 Piping Installation

3.5.1 General

3.5.2 Trench Excavation

3.5.2.1 Excavation

3.5.2.2 Dewatering

3.5.2.3 Removal of Rock

3.5.2.4 Removal of Unstable Material

3.5.3 Bedding

3.5.4 Placing Pipe

3.5.5 Jointing

3.5.6 Backfilling

3.5.6.1 General

3.5.6.2 Backfilling Pipe in Trenches

3.5.6.3 Backfilling Pipe in Fill Sections

3.5.6.4 Movement of Construction Machinery

3.5.6.5 Compaction

3.5.6.5.1 General Requirements

3.5.6.5.2 Minimum Density

3.5.6.6 Determination of Density

3.5.7 Pipeline Testing

3.5.7.1 Leakage Tests

3.5.7.2 Deflection Testing

3.6 Manhole Installation

3.7 Catch Basin Installation

Construction specification details that follow this format are provided in the U.S. Provisional Application Ser. No. 60/609,690, filed on Sep. 14, 2004, which has been incorporated herein by reference.

As another example of the wide scope of the systems and methods described herein, a system and method can be configured to allow detailed drawings to be generated (e.g., AutoCAD drawings) and for user-supplied construction notes to be placed on the generated detailed drawings. As an illustration, a computer-implemented system and method can be configured to create construction detail drawings for users. A user specifies information to a construction project generator software module that indicates what types, criteria and conditions the user needs in order to generate detail drawings for a construction project.

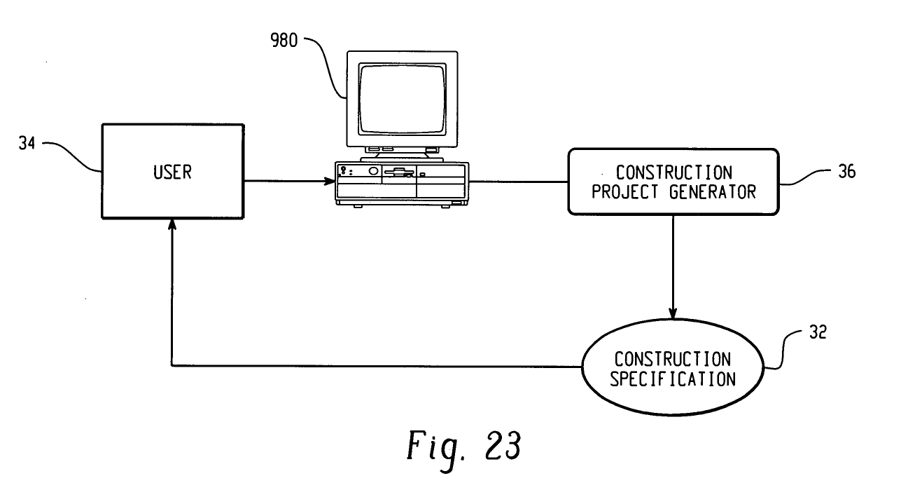

It is further noted that the systems and methods may be implemented on networked systems (e.g., internet, intranet, etc.). The systems and methods can also be implemented in other environments, such as on a single general purpose computer or workstation 980 as shown in FIG. 23.

The systems and methods may include data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of“a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context clearly dictates otherwise; the phrase “exclusive or” may be used to indicate situation where only the disjunctive meaning may apply.

It is claimed:

1. A computer-implemented method for generating specifications for site and infrastructure, or facility construction, or facility services, or process equipment, or general requirement portions of construction projects, comprising:
generating step-wise user interfaces in order to step a user through selection of construction project details;
wherein the construction project details that the user provides through the step-wise user interfaces include what construction materials and construction material-related conditions are associated with the construction project;
retrieving textual specification data from a data store based at least in part upon the construction project details that the user provided through the step-wise user interfaces;
generating a construction project specification, or portions of a construction project specification, based upon the retrieved textual specification data for use within a construction project.

2. The method of claim 1, wherein the construction material-related conditions which are available for specification by the user through the step-wise user interfaces include project conditions such as environmental conditions, native soil types, or project operating conditions.

3. The method of claim 1, wherein the step-wise generated user interfaces allow the user to step backwards and forwards through the different input screens, thereby allowing a user to change options selected in previous steps.

4. The method of claim 1, wherein the generated step-wise user interfaces are provided over a network to a user or are provided on a stand-alone computer to the user.

5. The method of claim 1, wherein the data store is a database;
wherein the database includes rules that determine what portions of textual specification data should be retrieved from the database based upon the user-specified input;
wherein the rules ensure that products designated in the user interfaces are correctly specified in the generated construction project specification.

6. The method of claim 5, wherein the rules are used to determine whether any concerns exist with respect to the user-specified data.

7. The method of claim 6, wherein the database contains alert data which are provided to the user if there is a determination that a concern exists with respect to the user-specified data.

8. The method of claim 1, wherein the generated construction project specification specifies construction materials, installation, and general requirements in a standardized format.

9. The method of claim 1, wherein the step-wise user interfaces are bypassed so that a user can provide the construction project details directly into a user interface.

10. The method of claim 1, wherein the construction project specification is generated in a text format so that any general word processing program can access it and the user can provide changes to the generated construction project specification.

11. The method of claim 1, wherein the step-wise user interfaces allow the user to select one or more project conditions; wherein the project conditions may be based upon which geographical region the construction is to take place.

12. The method of claim 11, wherein the step-wise user interfaces allow the user to select one or more best management practices; wherein the best management practices may be based upon which geographical region the construction is to take place.

13. The method of claim 1, wherein the step-wise user interfaces allow the user to provide information about whether the construction project is an environmentally sensitive project or a project classified by a federal, state, or local entity (e.g., United States Green Building Council LEED project) as being designed with environmental consideration, designed as a sustainable development, designed to utilize recycled materials, designed to accommodate an environmental need or concern, or designed as a low impact development.

14. The method of claim 13, wherein construction material manufactured with recycled material or construction materials manufactured with an environmentally conscious process, or construction materials claiming to be environmentally sensitive will be included in the construction project specification.

15. The method of claim 1, wherein the step-wise user interfaces allow the user to provide post installation testing requirements and what type of post installation testing; wherein a step-wise user interface provides to the user what testing is typically required for the geographical region where the piping construction project is to occur.

16. The method of claim 1, wherein the step-wise user interfaces allow the user to specify a project condition associated with the construction project; wherein an alert message is generated if the user has selected to include a particular type of construction material that is not recommended to be used with the selected project conditions; wherein the alert provides a recommendation of what product types or product modifications which may perform better in such conditions; wherein an alert message includes a reference to the source material or a hyperlink to a web page that provides technical or regulatory information that is the underlying basis for the alert message.

17. The method of claim 1, wherein the textual specification data stored in the data store includes best practices based upon industry practices or federal, state, municipal, or regional standards.

18. The method of claim 1, further comprising:
generating the construction project specification such that consistency is maintained in the specification requirements in that if one specified construction materials requires a particular performance or quality level, then other products intended for the same end purpose specified by the user have that requirement imposed upon them.

19. The method of claim 18, wherein a recycled materials requirement is specified through a user interface by the user; wherein other products specified by the user are checked to ensure conformance with the specified recycled materials requirement.

20. The method of claim 1, wherein the textual specification data from the data store includes information related to construction project cradle-to-grave issues;
wherein the construction cradle-to-grave issues include product type handling, submittal, installation, testing and maintenance issues.

21. The method of claim 1, further comprising:
comparing different construction material types with respect to the conditions provided by the user through the step-wise user interfaces.

22. The method of claim 21, wherein the comparison of the different construction materials is used to determine that a first product type works better than a second product with respect to the conditions provided by the user through the step-wise user interfaces.

23. The method of claim 1, wherein the textual specification data is updated in the data store with current best practices, industry standards, geographically specific piping construction requirements, and construction legal standards, thereby reducing need for a user from manually performing research and compiling information with respect to current best practices, industry standards, geographically specific piping construction requirements, and construction legal standards in order to draft a construction specification.

24. A data signal that is transmitted using a network, wherein the data signal includes the generated step-wise user interfaces of claim 1; wherein the data signal comprises packetized data that is transmitted through the network.

25. Computer-readable medium capable of causing a computing device to perform the method of claim 1.

26. A computer-implemented system for generating specifications for construction projects, comprising:
means for generating step-wise user interfaces in order to step a user through selection of construction project details;
wherein the construction project details that the user provides through the step-wise user interfaces include what product types and project-related conditions are associated with the construction project;
means for retrieving textual specification data from a data store based at least in part upon the construction project details that the user provided through the step-wise user interfaces;
means for generating a construction project specification based upon the retrieved textual specification data for use within a construction project.
